(19) United States
(12) Patent Application Publication
(10) Pub. No.: US 2010/0061676 A1
(43) Pub. Date: Mar. 11, 2010

(54) BEARING SYSTEM OR A SEALING SYSTEM USING A CARBON BASED SLIDING MEMBER

(75) Inventors: Kenichi Sugiyama, Tokyo (JP); Hiroshi Nagasaka, Yokohama-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: EBARA CORPORATION, Tokyo (JP)

(21) Appl. No.: 12/595,896

(22) PCT Filed: Apr. 18, 2008
(86) PCT No.: PCT/JP2008/057582

§ 371 Date: Oct. 14, 2009

(30) Foreign Application Priority Data
Apr. 20, 2007 (JP) 2007-111604

(51) Int. Cl. F16C 33/12

(52) U.S. Cl. 384/625

(57) ABSTRACT

An object of the present invention is to provide a bearing system or a sealing system which has excellent durability when used with the purified water as a lubricating liquid.

The present invention relates to a purified water-lubricated bearing system or a purified water-lubricated sealing system having a movable member and a stationary member, in which purified water having an electrical resistance in a range of 1-18.25 MΩcm is used as a lubricating liquid. The bearing system or the sealing system is characterized in that a diamond-like carbon film is formed over a slide surface of at least one of said movable member and said stationary member.

### TECHNICAL FIELD

The present invention relates to a bearing system or a sealing system using a carbon based sliding member, suitable for use in a rotating machine, such as pump, turbine, compressor and blower, as well as a rotating machine equipped with the same bearing system or the same sealing system, and more specifically to a bearing system or a sealing system using a carbon based sliding member for handling a liquid, wherein the liquid to be handled is purified water, or a rotating machine using the same bearing system or the same sealing system.

### BACKGROUND ART

Silicon carbides (SiC) and silicon nitrides (Si₃N₄) representative of silicon based ceramics have been commonly used for a bearing system or a sealing system in a rotating machine, such as pump, which handles water as a lubricating liquid. Use of these ceramics can facilitate formation of a film of hydroxide and/or hydrate in the form of gel over a sliding surface of the bearing system or the sealing system, during its sliding movement under lubrication with the water, and the ceramics that can provide such an effect is characterized advantageously in excellent performance in low frictional properties and wear resistance.

The SiC has been generally employed in constructing a journal bearing system and a thrust bearing system in a canned motor pump as both of a rotating component and a stationary component thereof. It is also well known in the sealing member for use in the pumps that the rotating component is made of SiC, whereas the stationary component is made of carbonaceous compact, or both are made of SiC.

### Patent Document Japanese Patent Laid-open Publication No. 2006-275286

### DISCLOSURE OF THE INVENTION

### Problems to be Solved by the Invention

In general, if the silicon based ceramics are used in an environment using tap water, which typically has an electrical resistance in a range of 0.001-0.1MΩcm, it will exhibit an excellent frictional and wearing property.

However, in the environment using purified water having the electrical resistance no lower than 1MΩcm as a handling liquid, because of the low concentration of Si contained in the water, a rate of dissolution of the Si-hydroxide or hydrate into the water becomes greater, resulting in erosion of silicon based ceramics being developed. Accordingly, the surface of the bearing or sealing portion could become rougher, leading to breakage of the water film and ending up with a direct contact and thus frictional wearing in the slide surface, and once in such circumstances, a rotational torque will possibly rise in an extremely short time, as compared to the case with the tap water, and the system will be no more put in use.

It is to be noticed in this connection that the electrical resistance should be 18.25 MΩcm for theoretical purified water, and there should be no higher value than that.

An object of the present invention is to provide a bearing system or a sealing system which has an excellent durability when used with the purified water as a lubricating liquid.

Another object of the present invention is to provide a bearing system or a sealing system, wherein ceramics are used in a member constructing the bearing system or the sealing system, and associatively a film of diamond-like carbon or polycrystalline diamond is formed over a slide surface of the member so as to improve the wear resistance.

Another object of the present invention is to provide a rotating machine with use of such a bearing system or a sealing system as described above.

### Means for Solving the Problems

According to a first invention of the present application, provided is a bearing system or a sealing system having a movable member and a stationary member, with which purified water having an electrical resistance in a range of 1-18.25 MΩcm is used as a lubricating liquid, the bearing system or the sealing system characterized in that a diamond-like carbon film is formed over a slide surface of at least one of the movable member and the stationary member.

In the bearing system or the sealing system according to the first invention as described above, preferably, the diamond-like carbon film has a Vicker's hardness, Hv, in a range of 1000-8000 and a film thickness no less than 1 μm but no greater than 5 μm. The film thickness no less than 1 μm is designated from the reason that with the film thickness less than the above value, any pinholes present in the film are likely to extend up to a base material and the purified water will possibly penetrate through those pinholes to induce erosion in the base material, while the film thickness no greater than 5 μm is designated from the reason that with the film thickness greater than the above value, a residual stress in the film will increase so that the film is more likely to be detached from the place. More preferably, the film thickness of the diamond-like carbon is no less than 1 μm but no greater than 3 μm.

In the bearing system or the sealing system according to the first invention as described above, preferably, the diamond-like carbon film is coated on a member of silicon nitride or silicon carbide. The reason for this is because the silicon nitride is hard, and the silicon carbide is hard and has excellent heat conductivity. Further, the diamond-like carbon film may be coated on a member of stainless steel. This is because the stainless steel has good corrosion resistance.

In addition, in the bearing system or the sealing system according to the first invention as described above, preferably, the diamond-like carbon film is formed over one of the movable member and the stationary member, whereas the other of the movable member and the stationary member is made of carbonaceous compact. The reason for this is that the carbonaceous compact has self-lubrication properties.

In the inventions as described above, the synthesizing process of the diamond-like carbon (DLC) may include the thermal filament CVD (chemical vapor deposition) process, the microwave plasma CVD process, the radio-frequency plasma CVD process, the DC discharge plasma process, the arc ion plating process, the spatter deposition process, the ion deposition process and the like. Specifically, from the viewpoint of the construction-related cost, it is preferred to use the microwave plasma CVD process, the radio-frequency plasma CVD process, the arc ion plating process or the spatter deposition process. Carbon compounds may be used as a raw material in the chemical vapor deposition process. The raw material may include: saturated hydrocarbons, such as methane, ethane, propane and butane; unsaturated hydrocarbons, such as ethylene, propylene, acetylene and butadiene; and aromatic hydrocarbons, such as benzene and toluene, to name a few. The physical vapor deposition process, such as ion plating or sputter deposition, may use a target substrate of carbon.

The diamond-like carbon film (DLC film) is an amorphous carbon film containing crystal (sp3) similar to the diamond, which is generally considered as being hard and having good slidability, and expected to be applied in a broad range of products, including sliding members for high loads, such as bearing systems and sealing systems as well as sliding members for light loads, such as protective films for magnetic storage media. Since the techniques as mentioned above are well known in the art, any further descriptions thereof are herein omitted.

In addition, the carbonaceous compact is typically produced in the following process. Initially, an amount of carbon powder made from coke or the like is mixed with a binding agent, referred to as a binder, while being heated, and the resultant material, after having been cooled, is crushed and sieved into powders. Then, in order to make a desired shape from a volume of powders, the volume of powders is placed into a molding die and pressed equally for making compact. The resultant compact is then applied with heat to remove any organic constituents in the binder, and the compact, after the removal of the organic constituents, is subject to the thermal treatment for graphitization or any treatment for impregnating the compact with resins or metals so as to reinforce the compact.

According to a second invention of the present application, provided is a bearing system or a sealing system having a movable member and a stationary member, with which purified water having an electrical resistance in a range of 1-18.25 MΩcm is used as a lubricating liquid, the bearing system or the sealing system characterized in that a polycrystalline diamond film is formed over a slide surface of at least one of the movable member and the stationary member.

In the bearing system or the sealing system according to the second invention as described above, preferably, the polycrystalline diamond film has a film thickness no less than 1 μm but no greater than 20 μm. The reason for the above designation of the film thickness is that with the film thickness greater than 20 μm, the residual stress in the film will increase so that the film is more likely to be detached from the place, and additionally with the film thickness greater than 20 μm, abnormal growth of diamond crystal is more likely to occur, thereby making it difficult for a normal slide surface to be produced. Another reason for the above designation of the film thickness is that with the film thickness less than 1 μm, there would be a chance that the purified water can penetrate through any pinholes in the diamond film to induce erosion in the base material. More preferably, the thickness of the polycrystalline diamond film is no less than 10 μm but no greater than 20 μm.

The size of the diamond crystal may be in a range of 0.001 μm to 15 μm, as observed from the top.

In the bearing system or the sealing system according to the second invention as described above, preferably, the polycrystalline diamond film is coated on a member of silicon nitride or silicon carbide. The reason for this is that the silicon nitride is hard and the silicon carbide is hard and has excellent heat conductivity.

Further, in the bearing system or the sealing system according to the second invention as described above, preferably, the polycrystalline diamond film is formed over one of the movable member and the stationary member, whereas the other of the movable member and the stationary member is made of carbonaceous compact. The reason for this is that the carbonaceous compact has self-lubrication properties.

The synthesizing process of the polycrystalline diamond may include the thermal filament CVD process, the microwave plasma CVD process, the radio-frequency plasma CVD process, the DC discharge plasma process, the arc discharge plasma jet process, the combustion flame process and the like. Specifically, from the viewpoint of the construction-related cost, it is preferred to use the thermal filament CVD process, and the microwave plasma CVD process. The raw material in the vapor phase synthesis processes as stated above may use a gaseous mixture of hydrogen gas mixed with hydrocarbon, such as methane, alcohol and acetylene, by a few percent. In some processes, the hydrogen gas may be mixed with carbon monoxide, carbon dioxide and the like, or may be added with other gases as a minor constituent. Those gaseous mixtures are common in that most parts of the raw material gas consist of hydrogen and the raw material gas is intended to be activated via the plasma formation or thermal excitation for use in the application. The activated hydrogen provides a strong etching effect on non-diamond carbon, while nearly no etching effect on the diamond. The vapor phase synthesis processes as described above may take advantage of this selective etching effect so as to suppress the growth of non-diamond constituents on the substrate but allow only the diamond to be deposited thereon for formation of the diamond film.

For the thermal filament CVD process, due to the fact that the substrate temperature during the film formation process rises to 800-1000° C., the base material may use inorganic materials, such as silicon, silicon nitride, alumina, and silicon carbide, as well as metals having a higher melting point, such as molybdenum and platinum.

### ADVANTAGES OF THE INVENTION

Although traditionally the silicon based ceramics, which exhibit excellent frictional and wearing properties under lubrication with the tap water, have been commonly used for a water-lubricated bearing system or sealing system, the silicon based ceramics could become worn out by erosion, if used under a sliding environment in purified water containing very few impurities, or an environment where components forming the bearing system or sealing system are in sliding contact with each other. In contrast to this, the bearing system or sealing system according to the present invention, in which a polycrystalline diamond film or a DLC film is formed over a slide surface of at least one of a pair of members which are brought into sliding contact with each other, can provide the bearing system or sealing system usable with the purified water, having excellent frictional and wearing properties and long service life.

### BRIEF DESCRIPTION OF THE DRAWINGS

FIG. 1 presents a result of an erosion-corrosion test (Test 1) for SiC conducted by using tap water. FIG. 1(a) represents the condition before the test, and FIG. 1(b) after the test;

FIG. 2 presents a result of an erosion-corrosion test (Test 2) for SiC conducted by using purified water. FIG. 2(a) represents the condition before the test, and FIG. 2(b) after the test;

FIG. 3 presents a result of an erosion-corrosion test (Test 3) for a polycrystalline diamond film conducted by using purified water. FIG. 3(a) represents the condition before the test, and FIG. 3(b) after the test;

FIG. 4 is a sectional view of an embodiment of a sliding bearing system according to the present invention;

FIG. 5 is a plan view of a disc plate as viewed along the A-A line of the bearing system of FIG. 4;

FIG. 6 is a sectional view illustrating a variation of a bearing system from the bearing system of FIG. 4;

FIG. 7 is a plan view of a disc plate as viewed along the B-B line of the bearing system of FIG. 6;

FIG. 8 is a sectional view of an embodiment of a sealing system according to the present invention;

FIG. 9 is an enlarged view of an area “C” of the sealing system of FIG. 6; and

FIG. 10 is a sectional view illustrating an example of a pump using a bearing system according to the present invention.

### EXPLANATION OF THE REFERENCE NUMERALS

1 Revolving shaft
10, 10a Bearing system
11, 11a Upper support
12, 12a Lower support
15, 15a, 16, 16a Disc plate
17, 17a Helical groove
18, 18a Recess

### EMBODIMENT OF THE INVENTION

Before presentation of a specific embodiment, an erosion-corrosion test conducted for a sintered body of SiC and a polycrystalline diamond film with use of tap water or purified water will be described.

Test material was positioned with its top surface vertical to the direction of water as being discharged from a nozzle having an internal diameter of 1 mm at a flow velocity of 28 m/s. A distance between an exit of the nozzle to the top surface of each test material was 25 mm, and the water continued to hit the top surface of the test material for a period of 100 hours and decrements in volume of the test material was compared. The electrical resistance of the tap water was 0.007 MΩcm, and the electrical resistance of the purified water was 18 MΩcm. The decrements in volume of respective materials are shown in Table 1. The Table 1 indicates that the SiC was not eroded-corroded at all when used with the tap water, but significantly eroded-corroded when used with the purified water. On the other hand, the polycrystalline diamond film was shown not to be eroded-corroded even with the purified water. Accordingly, in the under-ultra-purified water environment, the polycrystalline diamond film exhibits good corrosion resistance and can be used for coating the SiC to extend the service life of a slide member.

Also concerning the DLC film, which is a carbonaceous material similarly to the polycrystalline diamond film, the good corrosion resistance should be probably obtained.

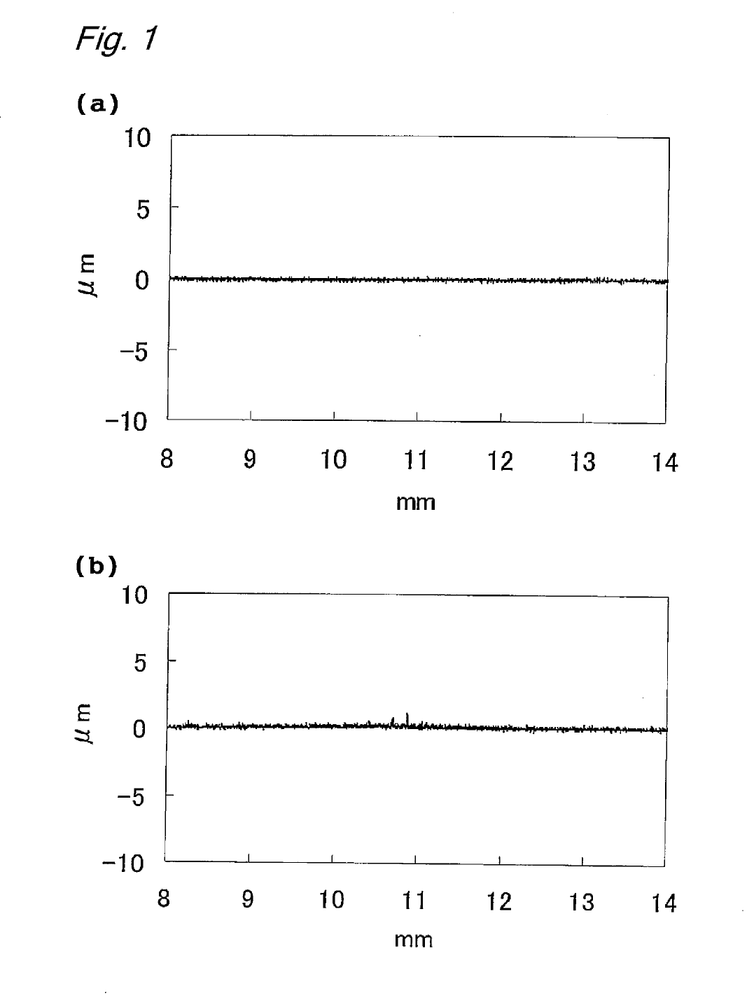

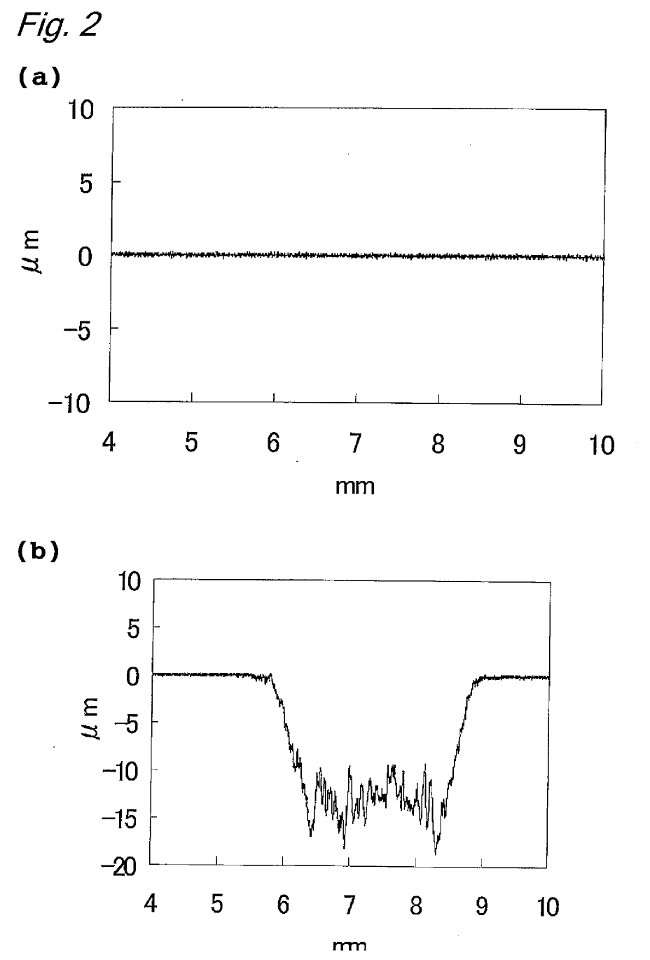

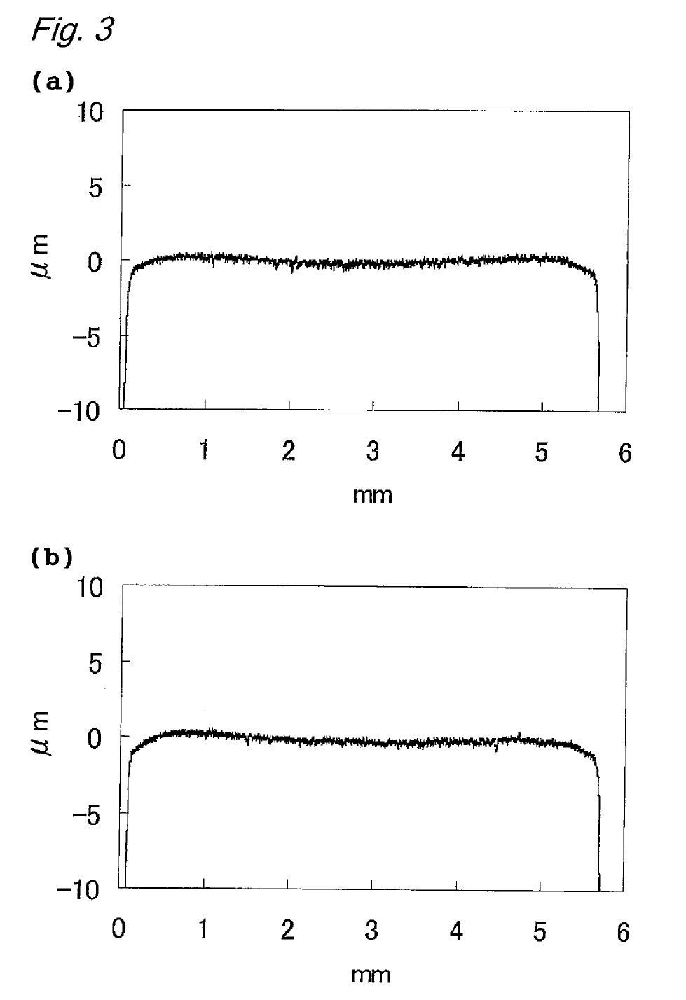

FIGS. 1 to 3 illustrate the erosion-corrosion condition for the respective materials before and after the Tests 1 to 3, respectively.

TABLE 1
Erosion-corrosion test result

| | | Film | Water | |
|---|---|---|---|---|
| | Test material | thickness | quality | Volume decreased |
| Test 1 | Silicon carbide | — | Tap water | 0.000(no greater than |
| | | | | detection limit) |
| Test 2 | Silicon carbide | — | Purified | 0.039 |
| | | | water | |
| Test 3 | Polycrystalline | 10 μm | Purified | 0.000(no greater than |
| | diamond film | | water | detection limit) |

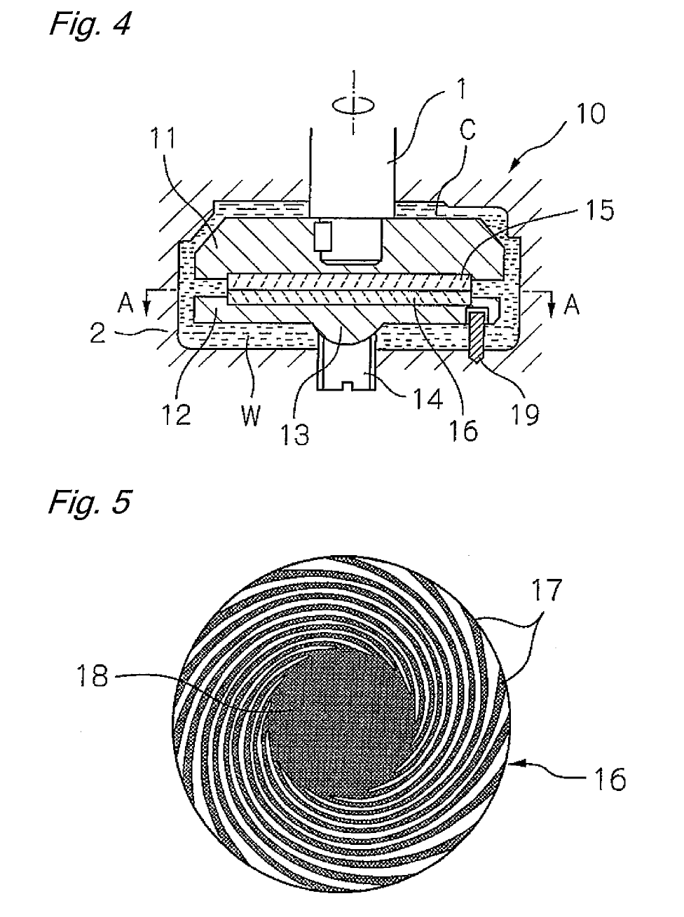

Referring to FIGS. 4 and 5, an embodiment of a bearing system according to the present invention is generally shown as 10. The bearing system 10 in this embodiment represents a thrust bearing system, which comprises an upper support 11 in the form of disc mounted to a tip (a lower end in FIG. 4) of a revolving shaft 1 and a lower support 12 in the form of disc disposed beneath the upper support, both supports disposed within a bearing system chamber “C” filled with purified water “w” serving as a lubricating liquid. The upper support 11 may be coupled to the revolving shaft 1 so as to rotate in association with the revolving shaft 1 by any known method, for example, by a key and key slot. The lower support 12 includes in a central region of a bottom surface (i.e., the side opposite to the upper support side) a convex portion 13 with a partially spherical surface having a predetermined radius, and this protruding portion is received within a concave portion with a partially spherical surface of a stationary shaft 14 fixedly mounted to the housing 2 in a lower central region, which housing defines the bearing system chamber C. The convex portion 13 is configured to snugly fit in the concave portion of the stationary shaft.

Disc plates 15 and 16, which can be made of ceramics, are securely attached on the surfaces of the upper support 11 and the lower support 12 facing to each other, or in the FIG. 4, the bottom surface of the upper support and the top surface of the lower support, in a known manner (e.g., by fastening with screws). A plurality of helical grooves 17 (black painted area in FIG. 5) is formed in the surface of the ceramics disc plate 16 facing to the ceramics disc plate 15, as shown in FIG. 5. In a central region of the surface of the disc plate 16 defining the helical grooves, a recess 18 (black painted area centrally located in FIG. 5) is formed in the form of circle so as to communicate with the helical grooves inside in the radial direction. It is to be noticed that reference numeral 19 designates a stop for preventing the rotation of the lower support 12. Preferably, the ceramics disc plate 15 or 16 may be made of silicon nitride or silicon carbide. The reason for this is that, in the context of the fact that if the hardness of the material of the disc plate used as a substrate on which the polycrystalline diamond film is to be formed is significantly low relative to the hardness of the polycrystalline diamond, the polycrystalline diamond film could not accommodate and thus not conform to the deformation of the disc due to the stress, leading to the film being detached from the disc plate serving as the substrate, the silicon nitride as well as the silicon carbide have extremely high hardness and free from the fear of the above phenomenon.

The orientation of the plurality of helical grooves is designated such that the ceramics disc plate 15 serving as the sliding member having the slide surface to be brought into contact with the helical grooves 17 for rotational movement can guide the water from the peripheral region of the disc plate 16 toward the centrally located recess 18 (black painted area in FIG. 5) so as to generate a dynamic pressure between two ceramics disc plates 15 and 16.

The sliding surfaces or the surfaces facing to each other (slide surface) of the ceramics disc plates 15 and 16 are provided with the polycrystalline diamond film that may be formed over the surface. The polycrystalline diamond film may be formed in the method as discussed in the above paragraph [0008]. Preferably, the polycrystalline diamond film has the film thickness no less than 1 μm but no greater than 20 μm. The reason for the above designation of the film thickness is that with the film thickness greater than 20 μm, the residual stress in the film will increase so that the film is more likely to be detached from the place, and additionally with the film thickness greater than 20 μm, abnormal growth of diamond crystal is more likely to occur, thereby making it difficult for a normal slide surface to be produced. Another reason for the above designation of the film thickness is that with the film thickness less than 1 μm, there would be a chance that the purified water can penetrate through any pinholes in the diamond film to induce erosion in the base material. More preferably, the film thickness is no less than 10 μm but no greater than 20 μm. Instead of the ceramics of silicon nitride or silicon carbide as stated above, the disc plates on which the polycrystalline diamond film is to be formed may be made of stainless steel characterized in excellent corrosion resistance.

Further, instead of the polycrystalline diamond film, the diamond-like carbon film may be formed over the sliding surfaces of the ceramics or the stainless steel disc plates 15 and 16 by the method as discussed in the above paragraph [0006]. Preferably, the diamond-like carbon film has the Vicker's hardness, Hv, in a range of 1000-8000 and the film thickness no less than 1 μm but no greater than 5 μm. The film thickness no less than 1 μm is designated from the reason that with the film thickness less than the above value, any pinholes present in the film are likely to extend up to the base material and the purified water will possibly penetrate through those pinholes to induce erosion in the base material, while the film thickness no greater than 5 μm is designated from the reason that with the film thickness greater than the above value, a residual stress in the film will increase so that the film is more likely to be detached from the place. More preferably, the film thickness of the diamond-like carbon is no less than 1 μm but no greater than 3 μm.

Instead of the polycrystalline diamond film or the diamond-like carbon film to be formed over both of the surfaces of the ceramics or the stainless steel disc plates 15 and 16 facing to each other, it may be formed exclusively over either one of the surfaces (e.g., the surface of the disc plate 16 facing to the disc plate 15). Further, if the polycrystalline diamond film or the diamond-like carbon is intended to be formed exclusively over either one surface, the other disc plate, which has no polycrystalline diamond film or the diamond-like carbon film formed thereon (e.g., the disc plate 15), may be made of carbonaceous compact.

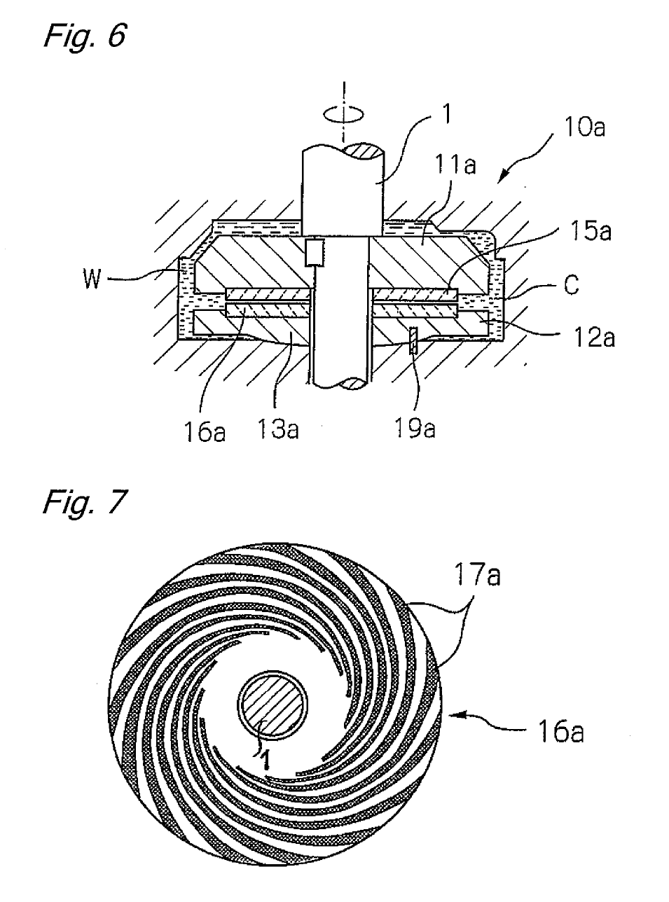

Referring now to FIGS. 6 and 7, a variation from the bearing system as shown in FIGS. 4 and 5 is shown as 10a. A shaft 1a of the bearing system 10a in this variation extends through a through hole formed through the centers of the disc-shaped upper and lower supports 11a and 12a, respectively, disposed within a bearing system chamber “C”. On the surfaces of the upper and the lower supports 11a and 12a facing to each other, or in this embodiment, the bottom surface of the upper support and the top surface of the lower support 12a, disposed are disc plates 15a and 16a, both having apertures through which the revolving shaft 1a can extend. The side of the lower support 12a not having the disc plate 16a attached thereon, or the bottom surface of the lower support 12a, includes a convex portion 13a that has been formed with a partially spherical surface having a large radius. This convex portion 13a is received within a concave portion with a complementary partially spherical surface formed in a housing 2a defining the bearing system chamber “C”. Reference numeral 19a designates a stop for preventing the rotation of the lower support.

Since the material of the disc plates 15a and 16a, configuration of the helical grooves which may be formed in one of the surfaces facing to each other, which define the sliding surfaces of the disc plates, and the polycrystalline diamond film or the diamond-like carbon film which may be formed over the sliding surface(s) of the disc plate(s) are similar to those in the above embodiment, therefore any further description thereof should be herein omitted.

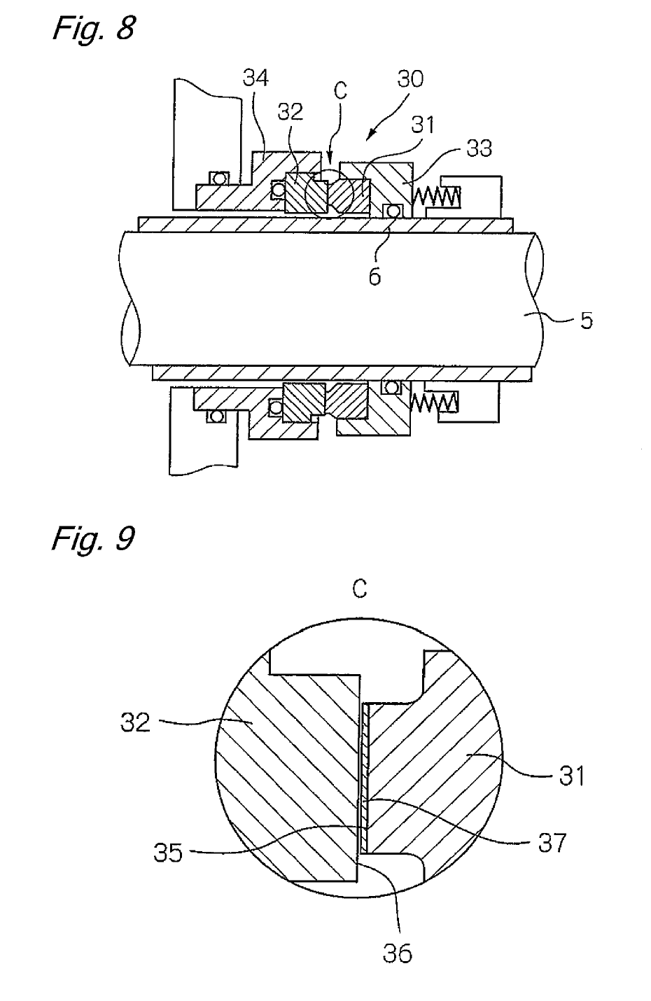

Referring now to FIGS. 8 and 9, an embodiment of a sealing system of mechanical sealing type according to the present invention is generally shown as 30. The sealing system 30 has: an annular movable sealing member 31 serving as a movable member, which is disposed externally around a sleeve 6 fitted externally around a revolving shaft 5; an annular stationary sealing member 32 serving as a stationary member; a holder 33 for holding the movable sealing member; and a holder 34 for holding the stationary sealing member. In this embodiment, the movable sealing member can be made of ceramics, such as silicon nitride or silicon carbide representative of a hard material. A polycrystalline diamond film 37 may be formed over a planar surface (sealing surface) 35 of the movable sealing member 31 facing to the stationary sealing member by the method as discussed in the above paragraph [0008]. Although the thickness of the polycrystalline diamond film 37 is 10 μm in this embodiment, any values of thickness no less than 1 μm but no greater than 20 μm may be useful. The reason for this is that with the film thickness greater than 20 μm, the residual stress in the film will increase so that the film is more likely to be detached from the place, and additionally with the film thickness greater than 20 μm, abnormal growth of diamond crystal is more likely to occur, thereby making it difficult for a normal slide surface to be produced. Another reason for the above designation of the film thickness is that with the film thickness less than 1 μm, there would be a chance that the purified water can penetrate through any pinholes in the diamond film to induce erosion in the base material. By forming the polycrystalline diamond film, a surface of the diamond film can serve as a sealing surface of the movable sealing member. The stationary sealing member 32 having a sealing surface 36 which is brought into contact with said sealing surface can be made of soft material, such as carbonaceous compact. This formation of the polycrystalline diamond film over one of a pair of sealing members, while making the other with the soft material can provide a quick fitting between sliding surfaces or the sealing surfaces and thus achieve excellent sealing performance as well as frictional and wearing properties.

It is to be noted that in opposite to the above manner, the stationary sealing member may be made of silicon nitride or silicon carbide, on which the polycrystalline diamond film may be formed, and then the movable sealing member may be made of the soft material, such as the carbonaceous compact.

It is further noted that instead of the polycrystalline diamond film, the diamond-like carbon film may be formed in place by the method as discussed in the above paragraph [0006].

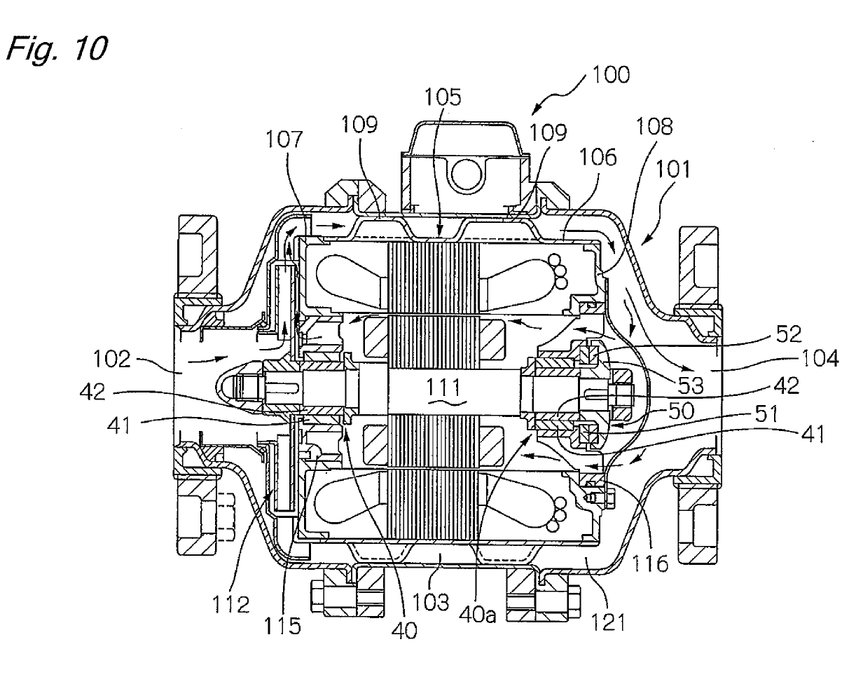

Referring now to FIG. 10, generally shown as 100 is a canned motor pump serving as a rotating machine to which a bearing system according to the present invention may be applied. This canned motor pump 100 comprises, an outer casing 101 defining an inlet port 102, a chamber 103 and an outlet port 104, and a motor housing 105 disposed within the chamber of the outer casing and having a cylindrical motor frame 106 and end plates 107 and 108 attached to opposite ends of the motor frame. A revolving shaft 111 is arranged within the motor housing 105 and rotationally supported by bearing systems 40, 40a and 50 mounted in respective end plates 107 and 108, to which the present invention may be applied. The end of the revolving shaft in the inlet port side extends through the end plate 107 and protrudes into the inlet port side, and an impeller 112 is fixed to that protruding portion. A plurality of ribs 109 is formed on an outer circumference of the cylindrical motor frame, each spaced apart from each other in the circumferential direction, and a gap formed between adjacent ribs within a space between the outer casing 101 and the motor frame 106 provides a passage 121 through which a volume of fluid urged from the impeller flows toward the outlet port 104.

The bearing system 40 and 40a represent radial bearing systems, each having a hollow cylindrical outer member or a stationary bearing member 41 fixed to bearing system housing 115 or 116, which in turn is fixed to end plate, respectively, and an inner or a movable bearing member 42 fixed to the revolving shaft 111 at a location corresponding to the stationary bearing member, respectively. Both bearing members, similar to the disc plates of the bearing systems as illustrated in FIGS. 4 to 7, may be made of ceramics, such as silicon nitride and silicon carbide or metals, such as stainless steel. Those surfaces of the bearing members 41 and 42 facing to each other, or specifically the internal circumferential surface (sliding surface or slide surface) of the outer stationary bearing member 41 and the external circumferential surface (sliding surface or slide surface) of the inner movable bearing member 42, may be provided with the polycrystalline diamond film, respectively, which may be formed by the method as discussed in the above paragraph [0008]. Although the thickness of the polycrystalline diamond film is 10 μm in this embodiment, any values of thickness no less than 1 μm but no greater than 20 μm may be useful. The reason for this is that with the film thickness greater than 20 μm, the residual stress in the film will increase so that the film is more likely to be detached from the place, and additionally with the film thickness greater than 20 μm, abnormal growth of diamond crystal is more likely to occur, thereby making it difficult for a normal slide surface to be produced. Another reason for the above designation of the film thickness is that with the film thickness less than 1 μm, there would be a chance that the purified water can penetrate through any pinholes in the diamond film to induce erosion in the base material. It is to be noted that instead of the polycrystalline diamond film, the diamond-like carbon film may be formed in place.

The bearing system 50 represents a thrust bearing system, comprising an annular stationary bearing member 51 mounted to an end portion (right end in FIG. 7) of the bearing system housing 116 and a rotational bearing member 52 located adjacent to said bearing member and mounted to a bearing support member 53 fixed to the revolving shaft 111. Both bearing members, similar to the disc plates of the bearing systems as illustrated in FIGS. 4 to 7, may be made of ceramics, such as silicon nitride and silicon carbide or metals, such as stainless steel. Those surfaces of the bearing members 51 and 52 facing to each other, or specifically the surface (sliding surface) of the stationary bearing member 51 and the surface (sliding surface) of the movable bearing member 52, may be provided with the polycrystalline diamond film, respectively, which may be formed by the method as discussed in the above paragraph [0008]. Although the thickness of the polycrystalline diamond film is 10 μm in this embodiment, any values of thickness no less than 1 μm but no greater than 15 μm may be useful. The reason for this is that with the film thickness greater than 15 μm, the residual stress in the film will increase so that the film is more likely to be detached from the place, while with the film thickness less than 1 μm, there would be a chance that the purified water can penetrate through any pinholes in the diamond film to induce erosion in the base material. It is to be noted that instead of the polycrystalline diamond film, the diamond-like carbon film may be formed in place.

1. A bearing system or a sealing system having a movable member and a stationary member, in which purified water having an electrical resistance in a range of 1-18.25 MΩcm is used as a lubricating liquid, said bearing system or said sealing system characterized in that a diamond-like carbon film is formed over a slide surface of at least one of said movable member and said stationary member.

2. A bearing system or a sealing system in accordance with claim 1, characterized in that said diamond-like carbon film has a Vicker's hardness, Hv, in a range of 1000-8000 and a film thickness no less than 1 μm but no greater than 5 μm.

3. A bearing system or a sealing system in accordance with claim 1, characterized in that said diamond-like carbon film is coated on a silicon nitride member or a silicon carbide member.

4. A bearing system or a sealing system in accordance with claim 1, characterized in that said diamond-like carbon film is coated on a stainless steel member.

5. A bearing system of sealing system in accordance with claim 1, characterized in that said diamond-like carbon film is formed over one of said movable member and said stationary member, whereas the other of said movable member and said stationary member is made of carbonaceous compact.

6. A bearing system or a sealing system having a movable member and a stationary member, in which purified water having an electrical resistance in a range of 1-18.25 MΩcm is used as a lubricating liquid, said bearing system or said sealing system characterized in that a polycrystalline diamond film is formed over a slide surface of at least one of said movable member and said stationary member.

7. A bearing system or a sealing system in accordance with claim 6, characterized in that said polycrystalline diamond film has a film thickness no less than 1 μm but no greater than 20 μm.

8. A bearing system or a sealing system in accordance with claim 6, characterized in that said polycrystalline diamond film is coated on a silicon nitride member or a silicon carbide member.

9. A bearing system of sealing system in accordance with claim 6, characterized in that said polycrystalline diamond film is formed over one of said movable member and said stationary member, whereas the other of said movable member and said stationary member is made of carbonaceous compact.

10. A rotating machine comprising at least one of a bearing system and a sealing system in accordance with any of claim 1 to 9.
